(19) United States
(12) Patent Application Publication
(10) Pub. No.: US 2026/0109878 A1
(43) Pub. Date: Apr. 23, 2026

(54) SELF-MINERALIZING MULTIFUNCTIONAL COATING COMPOSITION

(71) Applicants: Elham Fini, Phoenix, AZ (US); Albert Hung, Tempe, AZ (US)

(72) Inventors: Elham Fini, Phoenix, AZ (US); Albert Hung, Tempe, AZ (US)

(21) Appl. No.: 19/425,713

(22) Filed: Dec. 18, 2025

Related U.S. Application Data
(63) Continuation of application No. 18/156,901, filed on Jan. 19, 2023, now Pat. No. 12,540,255.
(60) Provisional application No. 63/300,710, filed on Jan. 19, 2022.

(51) Int. Cl. C09D 177/12; C09D 7/20; C09D 7/40; C09D 7/61; C09D 7/65

(52) U.S. Cl. CPC C09D 177/12; C09D 7/20; C09D 7/61; C09D 7/65; C09D 7/67

(57) ABSTRACT

A coating composition includes alkaline mineral particles including an oxide of an alkaline earth metal and an amine-containing polymer. The amine-containing polymer is adsorbed on the alkaline mineral particles. Forming a coating composition includes at least partially coating alkaline mineral particles with an amine-containing polymer and dispersing the alkaline mineral particles in a liquid to yield the coating composition. The alkaline mineral particles include an oxide of an alkaline earth metal.

### CROSS-REFERENCE TO RELATED APPLICATIONS

This application is a continuation of U.S. patent application Ser. No. 18/156,901 filed on Jan. 19, 2023, which claims the benefit of U.S. Patent Application No. 63/300,710 filed on Jan. 19, 2022, which are incorporated herein by reference in their entirety.

### STATEMENT OF GOVERNMENT SUPPORT

This invention was made with government support under 1928807 awarded by the National Science Foundation. The government has certain rights in the invention.

### TECHNICAL FIELD

This invention relates to a self-mineralizing multifunctional coating composition for carbon sequestration, passive cooling, and increasing albedo.

### BACKGROUND

Buildings are responsible for 41% of the US primary energy consumption and generate nearly 40% of annual global CO₂ emissions, due to their operation that involves heating, cooling, lighting, and plug loads. Buildings are also the main contributor to the urban heat island (UHI) effect in major cities due to the use of construction materials that absorb and store heat.

### SUMMARY

This disclosure describes self-mineralizing multifunctional coating composition for carbon sequestration, passive cooling, and increasing albedo. The coating composition includes particles of an alkaline mineral that can carbonate (e.g., self-mineralize) and serve as a permanent carbon-storage medium. The coating composition also includes an amine-containing polymer that initiates CO₂ capture and diffusion and imparts ductility to coatings formed from the coating composition. The amine-containing polymers can be sourced from waste plastics. Reflection of incident light or radiation by a coating formed from the coating composition aids in cooling the roof or façade of a building to reduce energy consumption and mitigate the urban heat island effect.

In a first general aspect, a coating composition includes alkaline mineral particles including an oxide of an alkaline earth metal and an amine-containing polymer. The amine-containing polymer is adsorbed on the alkaline mineral particles.

Implementations of the first general aspect can include one or more of the following features.

In some cases, the alkaline mineral particles include one or more of MgO, CaO, CaSiO₃, Ca₂SiO₄, and Mg₂SiO₄. The alkaline mineral particles can have a diameter in a range of about 1 nm to about 100 nm. In some cases, the amine-containing polymer includes one or more of polyethylene terephthalate, poly(methyl methacrylate), poly(allyl amine), poly(vinyl amine), and poly(ethylene imine). In some cases, the first general aspect further includes water, alcohol, or both. In some implementations, the first general aspect further includes one or more resin binders. In some cases, the one or more resin binders includes an epoxy resin, an acrylic resin, or both. The one or more resin binders can include poly(methyl methacrylate), poly[(vinyl acetate)-co-(methy/ethyl/butyl acrylate)], or both. In some implementations, the first general aspect further includes a silicone polymer. The silicone polymer can include a functionalized polysilsesquioxane. In some cases, the functionalized polysilsesquioxane includes poly(dimethylsiloxane).

In some cases, the first general aspect further includes one or more pigments. The coating composition can be a paint. A coating can be formed from the first general aspect. In some cases, the coating composition reflects solar radiation. In some implementations, storing carbon dioxide includes contacting carbon dioxide with the first general aspect, capturing the carbon dioxide with the amine-containing polymer, transporting the carbon dioxide to the oxide of the alkaline earth metal, and forming an alkaline earth metal carbonate species.

In a second general aspect, forming a coating composition includes at least partially coating alkaline mineral particles with an amine-containing polymer and dispersing the alkaline mineral particles in a liquid to yield the coating composition. The alkaline mineral particles include an oxide of an alkaline earth metal.

Implementations of the second general aspect can include one or more of the following features.

In some cases, the coating composition further includes one or both of a resin binder and a silicone polymer. In some cases, the coating composition further includes one or more pigments. The alkaline mineral particles can include one or more of MgO, CaO, CaSiO₃, Ca₂SiO₄, and Mg₂SiO₄. In some implementations, the alkaline mineral particles include nanoparticles. In some cases, the amine-containing polymer includes one or more of polyethylene terephthalate, poly(methyl methacrylate), poly(allyl amine), poly(vinyl amine), and poly(ethylene imine). In some implementations, the amine-containing polymer is formed through aminolysis with an amine containing reagent. In some cases, the amine containing reagent includes ethylene diamine. In some implementations, the amine containing reagent includes ethylene amine oligomers, alkyl diamines, and alkyl amine oligomers. The ethylene amine oligomers can include one or more of diethylenetriamine, triethylenetetramine, tetraethylenepentamine, and pentaethylenehexamine. In some cases, the alkyl diamines include one or more of propanediamine, butanediamine, and pentanediamine. In some implementations, the second general aspect further includes multifunctional amine reagents. The multifunctional amine reagents can promote crosslinking of the amine-containing polymer. In some cases, the multifunctional amine reagents include one or more of tris(2-aminoethyl)amine, tris(3-aminoethyl)amine, and low molecular weight branched poly(ethylene imine).

Advantages provided by aspects of this invention include the ability to capture and store atmospheric carbon, reduce energy consumption, and increase utilization of waste streams and renewable resources. Formulating the coating composition described herein and allowing carbonation to occur on-site allows for capture and utilization of carbon. Advantages of on-site carbon capture include reduction in energy expenditures related to absorbent regeneration and CO₂ transport and incorporation of high mineral fractions in the final material without increasing the mineral or solvent content of the coating composition. In addition, an increased strength of coatings formed from the composition due to mineralization over time can compensate for losses in mechanical strength due to aging processes.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1A depicts an example of a CO₂-absorbent composite in the form of a coating.

FIG. 1B depicts amine polyethylene terephthalate (amine-PET).

### DETAILED DESCRIPTION

This disclosure describes self-mineralizing multifunctional coating compositions and composites formed therefrom. The coating composition includes an amine-containing polymer and reflective particles of an alkaline mineral. The amine-containing polymer facilitates capture of carbon dioxide (CO₂) at atmospheric concentrations by a composite formed from the coating composition. The captured CO₂ diffuses through the composite and reacts with the alkaline mineral to yield a carbonate. The coatings provide CO₂ capture and storage as well as solar reflectance. The composite can be in the form of a paint. When the paint is used to coat building materials in an urban setting, the paint promotes cooling of the building materials. This cooling can reduce energy consumption and mitigate urban heat island effects.

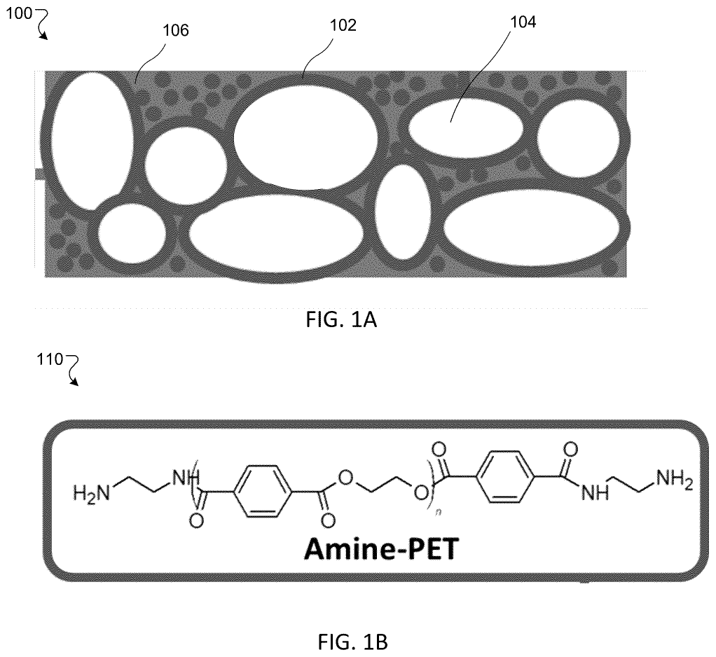

FIG. 1A shows a schematic of a composite 100 in the form of a coating. Composite 100 is formed from a composition that includes amine-containing polymer 102 and alkaline mineral particles 104. Amine-containing polymer 102 is adsorbed on alkaline mineral particles 104. The adsorption can include physical adsorption, chemical adsorption, or both. Examples of forces present in physical adsorption include electrostatic forces and van der Waals forces. One example of chemical adsorption is covalent bonding. The amine-containing polymer 102 facilitates the capture of CO₂ and provides a percolating network for transporting the CO₂ to the alkaline mineral particles 104. The thickness of the amine-containing polymer 102 on alkaline mineral particles 104 can be in a range of about 0.01 μm to about 1.0 μm.

The composite 100 can include additives 106. The additives 106 can include resin binders, silicone polymers, or both for additional strength or ductility. Suitable resin binders include epoxy resins or acrylic resins such as poly(methyl methacrylate) (PMMA) or poly[(vinyl acetate)-co-(methy/ethyl/butyl acrylate)]. Suitable silicone polymers include methyl/phenyl/methoxy/aminopropyl-functionalized polysiloxanes such as poly(dimethylsiloxane) (PDMS) or similarly functionalized polysilsesquioxanes.

The alkaline mineral particles 104 include an oxide of an alkaline earth metal that can store CO₂ by reacting with CO₂ to form a carbonate species. Suitable alkaline earth oxides include magnesium oxide (MgO), calcium oxide (CaO), calcium inosilicate (CaSiO₃), calcium orthosilicate (Ca₂SiO₄), forsterite olivine (Mg₂SiO₄). The alkaline mineral particles 104 can be nanoparticles (e.g., with a diameter in a range of about 1 nm to about 100 nm).

The amine-containing polymer is configured to capture CO₂ at atmospheric concentrations. Amine groups can be incorporated into a polymer through aminolysis or transesterification with an amine-containing reagent to yield the amine-containing polymer. The amine-containing polymer can include terminal amine groups. Polymers suitable for forming the amine-containing polymer include polyethylene terephthalate (PET), PMMA, poly(allyl amine) (PAA), poly(vinyl amine) (PVAm), poly(ethylene imine) (PEI). Amine-containing reagents suitable for the aminolysis or transesterification reaction include ethylene diamine, related ethylene amine oligomers (e.g., diethylenetriamine, triethylenetetramine, tetraethylenepentamine, pentaethylenehexamine), longer alkyl diamines (e.g., propanediamine, butanediamine, pentanediamine) and related alkyl amine oligomers. In some cases, multifunctional amine reagents are used to promote crosslinking of the amine-containing polymer. Suitable multi-functional reagents include tris(2-aminoethyl)amine, tris(3-aminoethyl)amine, low molecular weight branched PEI.

Amine-functionalized waste polyethylene terephthalate (PET) can be used as a precursor material for the amine-containing polymer. The PET can be functionalized with amines through a transesterification reaction. FIG. 1B depicts an example of an amine-containing polymer produced from polyethylene terephthalate (PET) and ethylene diamine. The amine groups of ethylene diamine are incorporated into PET through transesterification of ester bonds to yield amine-PET 110. The PET used for the synthesis of amine-PET 110 can be sourced from waste plastic. The transesterification process breaks down the waste plastic and converts it into a slurry. While PET is insoluble in most solvents, micronized PET particles with an amine-functionalized surface can be dispersed in water or alcohol as a slurry that can be used as a coating. Suitable alcohols include ethanol or propanol.

The composite 100 can include one or more pigments. The composite 100 can be a paint. Carbonation of alkaline mineral particles 104 by CO₂ capture results in an increase in radiation reflectance of the composite 100. When the composite 100 is used as a paint on a structure, this increase in radiation reflectance decreases the energy consumption for cooling the structure.

The mechanical properties of the coating can be measured as a function of CO₂ exposure time to determine how the mechanical properties change with increased carbonation. Elasticity and yield strength can be measured by tensile testing or dynamic mechanical analysis (DMA), and hardness can be measured by indentation measurements. Since the degree of carbonation can vary with depth into the sample, DMA can give an approximation of the average properties of the sample whereas indentation measurements can better determine the properties of the carbonated surface. Microindentation (e.g., Vickers hardness test) can be used to obtain values for the mechanical properties of the composite as a whole.

The morphology of the composite 100 can be examined by scanning electron microscopy (SEM). Fourier transform infrared spectroscopy (FTIR) can be used to measure chemical composition. An average composite thickness can be estimated based on the Brunauer-Emmett-Teller (BET) surface area and thermogravimetric analysis (TGA) measurements of the organic-inorganic mass ratio. The composite thickness and morphology can also be examined by cutting sample cross-sections of the composite and imaging them with SEM or atomic force microscopy (AFM). The crystal structure can be characterized by X-ray diffraction (XRD). A smaller size of the alkaline mineral particles 104 provides more surface area and accelerates CO₂ absorption. Table 1 lists properties of MgO and its estimated maximum capacity for CO₂ absorption.

TABLE 1
Properties of MgO and estimated capacity for CO₂ absorption.

| | | |
|---|---|---|
| Molecular Weight | 40.3 | g/mol |
| Density | 3.6 | g/cm³ |

| | |
|---|---|
| Max. CO₂ capacity of mineral | 1.09 g (CO₂)/g (mineral) |
| Max. CO₂ capacity of paint | 262 g (CO₂)/m² |
| (0.2 mm thick coating)* | 3,800 m²/metric ton CO₂ |

*Calculated based on paint composed of 60 wt % mineral content, density of organic phase 1.2 g/cm³, and ignoring any CO₂ held by organic amines

The speed of CO₂ absorption and the capacity of the mineral powders or composite mixtures can be measured using a TGA instrument where CO₂ concentration, water-vapor content, and temperature can be controlled and monitored in real-time. For measurements of absorption over longer periods of days or weeks, a system can be used in which a closed container is pressurized with CO₂ gas and the pressure decrease is measured over time.

The absorption speed and diffusion depth of CO₂ can be measured in a closed-chamber system using samples of the composite greater than 0.5 mm thick with only the top surface exposed to better mimic the performance of a paint coating. After CO₂ exposure, the sample can be fractured or cut to expose a cross-section that can be characterized by SEM and energy-dispersive X-ray spectroscopy (EDX). Microscopy of a simple fractured sample can reveal qualitative aspects of particle packing, morphology change with CO₂ absorption, and adhesion between inorganic and organic phases. Cutting and polishing the sample can reveal cross-sections of mineral particles, and the distribution of carbon in the section can be mapped by EDX. This analysis shows the depth of CO₂ diffusion into the coating as well as into any individual mineral particle.

Combined AFM and infrared absorption spectroscopy (AFM-IR) can be used to analyze the organic-inorganic surface. AFM-IR uses a wavelength-tunable IR laser to simultaneously perform AFM imaging and mapping of IR absorption by photothermal expansion. AFM-IR can map the composition, mechanics, and morphology of the mineral-amine-polymer interface with sub-micron resolution.

Ab initio and density functional theory (DFT) calculations and molecular dynamics (MD) simulations can be used to analyze the coating in 3 ways. (1) The simulations can assist in screening candidate alkaline minerals and binders, at different molar ratios as applicable, by simulating their CO₂ diffusion coefficient and computing their CO₂ absorption capacity. (2) The calculations can be used to gain atomistic and molecular-level insight into the mechanisms underlying CO₂ absorption as well as interactions between CO₂ and the composite ingredients. This will be done by computing the coordination number, total energy, and residence time of CO₂ and its interaction energy and radial distribution function with respect to the coating components. Simulations can be carried out at different temperatures and water contents in the binder to further analyze the influence of these factors on the kinetics of CO₂. (3) The calculations can be used to test the influence of carbonation on the hardness and mechanical properties of the coating at the nanometer scale (e.g., on the order of a few million atoms).

The thermal emissivity of the disclosed coatings can be analyzed using the material's thermal properties, such as thermal conductivity, density, and specific heat. The optical characteristics of the material can be analyzed including chromatic coordinates and whiteness to understand their influence on the radiation absorption of the material. Reflective measurements within the range of solar radiation can be made to obtain the solar reflectance of the material. A solar simulation analysis and infrared thermography (IRT) can be performed to test the behavior of material surface in interaction with solar irradiance. The results can be validated using the findings from the physical test with a scaled demonstrator. Energy simulation with EnergyPlus™ can be used to assess the impacts of the disclosed coatings on the cooling- and total energy savings of a sample building. The results can help estimate the energy-related carbon avoidance to be achieved using the disclosed coatings.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1.-20. (canceled)

21. A coating composition comprising:
alkaline mineral particles comprising an oxide of an alkaline earth metal; and
an amine-containing polymer comprising poly(allyl amine) or poly(vinyl amine), wherein the amine-containing polymer is adsorbed on the alkaline mineral particles.

22. The coating composition of claim 21, wherein the alkaline mineral particles comprise one or more of MgO, CaO, CaSiO₃, Ca₂SiO₄, and Mg₂SiO₄.

23. The coating composition of claim 22, wherein the alkaline mineral particles have a diameter in a range of about 1 nm to about 100 nm.

24. The coating composition of claim 21, further comprising water, alcohol, or both.

25. The coating composition of claim 24, further comprising one or more resin binders.

26. The coating composition of claim 25, wherein the one or more resin binders comprises an epoxy resin, an acrylic resin, or both.

27. The coating composition of claim 25, wherein the one or more resin binders comprise poly(methyl methacrylate), poly[(vinyl acetate)-co-(methyl/ethyl/butyl acrylate)], or both.

28. The coating composition of claim 21, further comprising a silicone polymer.

29. The coating composition of claim 28, wherein the silicone polymer comprises a functionalized polysilsesquioxane.

30. The coating composition of claim 29, wherein the functionalized polysilsesquioxane comprises poly(dimethylsiloxane).

31. The coating composition of claim 21, further comprising one or more pigments.

32. A coating formed from the coating composition of claim 21.

33. The coating composition of claim 21, wherein the coating composition reflects solar radiation.

34. A method of storing carbon dioxide, the method comprising:
contacting carbon dioxide with the coating composition of claim 21;
capturing the carbon dioxide with the amine-containing polymer;
transporting the carbon dioxide to the oxide of the alkaline earth metal; and
forming an alkaline earth metal carbonate species.

35. A method of forming a coating composition, the method comprising:
at least partially coating alkaline mineral particles with an amine-containing polymer comprising poly(allyl amine) or poly(vinyl amine), wherein the alkaline mineral particles comprise an oxide of an alkaline earth metal; and
dispersing the alkaline mineral particles in a liquid to yield the coating composition.

36. The method of claim 35, wherein the alkaline mineral particles comprise one or more of MgO, CaO, CaSiO₃, Ca₂SiO₄, and Mg₂SiO₄.

37. The method of claim 36, wherein the alkaline mineral particles have a diameter in a range of about 1 nm to about 100 nm.

38. The method of claim 35, wherein the coating composition further comprises a resin binder.

39. The method of claim 35, wherein the coating composition further comprises a silicone polymer.

40. The method of claim 35, wherein the coating composition further comprises one or more pigments.
